(19) United States
(12) Patent Application Publication
(10) Pub. No.: US 2026/0260953 A1
(43) Pub. Date: Sep. 3, 2026

(54) BATTERY MANAGEMENT SYSTEM STRUCTURE AND BATTERY COMPRISING SAME

(71) Applicant: CPS Technology Holdings LLC, New York, NY (US)

(72) Inventors: Ethan Michael CORR, Milwaukee, WI (US); Nicholas E. ELISON, Mequon, WI (US)

(21) Appl. No.: 18/876,003

(22) PCT Filed: Jul. 20, 2023
(86) PCT No.: PCT/US2023/070579

§ 371 Date: Dec. 17, 2024

Related U.S. Application Data
(60) Provisional application No. 63/390,848, filed on Jul. 20, 2022.

(51) Int. Cl. H01M 10/42; B60L 50/64; H01R 12/72; H01R 13/627

(52) U.S. Cl. CPC H01M 10/425; B60L 50/64; H01R 12/724; H01R 13/6272; H01M 2010/4271; H01M 2010/4278; H01M 2220/20; H01R 2201/26

(57) ABSTRACT

A battery management system structure has a housing having a housing interior and a housing exterior, a connector shell forming an interior and at least one electrically conductive signal pin. The connector shell is integrally formed with the housing and is positioned on the housing exterior. Each of the at least one electrically conductive signal pins has a first elongated portion positioned partially within the connector shell interior and extending into the housing interior, a second elongated portion positioned within the housing interior and a shoulder portion coupling the first elongated portion to the second elongated portion. The shoulder portion is arranged with a bend so that the first elongated portion is substantially orthogonal to the second elongated portion. A battery including the battery management system structure is also provided.

### TECHNICAL FIELD

This disclosure relates to vehicle batteries, and in particular to a connector arrangement for a vehicle battery.

### BACKGROUND

Batteries are an essential part of many devices, including motor vehicles. Historically, motor vehicles were equipped with a single battery, e.g., a lead acid battery, used to both start the vehicle's motor as well as to power the other systems of the vehicle, e.g., charging system, operation while running, lighting, accessories, etc. More recently, electric vehicles and hybrid gasoline/electric vehicles (collectively referred to herein as electric vehicles or EVs), rely on one or more Li-Ion batteries to provide energy to power electric motors that cause the vehicle's wheels to move and to also power the other systems of the vehicle. Such an arrangement results in a single point of failure where failure of the lead-acid battery or failure of the Li-Ion batteries used to provide locomotive energy renders all other vehicle systems inoperative. The result is that a driver may not be able to use emergency alerting systems, active hazard lights, etc.

Battery monitoring has become an aspect of focus as the importance of batteries in vehicles increases. Battery monitoring typically employs the use of battery monitoring hardware and software. Whether the battery monitoring hardware is integrated within the battery or external to the battery or both, electrical connections from the battery to support the monitoring are needed. However, the more points of entry to the internal housing of the battery and its components, i.e., the more openings in the battery housing, the greater the chances for battery contamination, leakage and failure due to environmental conditions. The environment that vehicle batteries are used in is harsh owing to temperature extremes, unpredictable weather, caustic chemicals and moisture issues, etc. Thus, additional openings in the battery housing that are not properly sealed can lead to premature battery and/or battery monitoring failure.

Batteries with integrated battery monitoring and/or controller components and systems arc also more complex to assemble than traditional batteries such as lead acid batteries which typically have a number of interconnected cells and only a positive and negative terminal protruding through the battery housing. For example, electrical connections that require additional soldering/welding than traditional lead acid batteries adds assembly complexity, additional points of failure, and the like. Combining the complexity of assembly with the number of openings in the housing needed to support battery management functionality to create a reliable battery is a challenging combination.

### SUMMARY

Some embodiments advantageously provide a connector arrangement for monitoring a vehicle battery, such as but not limited to a non-cranking Li-Ion battery, that is simpler to assemble than current arrangements, provides reliable electrical communication paths from the exterior of the battery to the interior of the battery housing, and that provides a hermetic seal once the corresponding connecter/cable is plugged into the battery connector. Such connector arrangements can be used in batteries such as vehicle batteries and with various battery technologies such as lead acid and Li-Ion batteries, and with batteries that have different purposes such as auxiliary batteries, back-up batteries and batteries intended to provide energy for locomotion. These auxiliary batteries are generally referred to herein as non-cranking batteries.

In one embodiment, a battery management system structure has a housing having a housing interior and a housing exterior, a connector shell forming an interior and at least one electrically conductive signal pin. The connector shell is integrally formed with the housing and is positioned on the housing exterior. Each of the at least one electrically conductive signal pins has a first elongated portion positioned partially within the connector shell interior and extending into the housing interior, a second elongated portion positioned within the housing interior and a shoulder portion coupling the first elongated portion to the second elongated portion. The shoulder portion is arranged with a bend so that the first elongated portion is substantially orthogonal to the second elongated portion.

In accordance with one aspect of this embodiment, the first elongated portion, the second elongated portion and the shoulder portion are formed as a unitary structure. In accordance with another aspect of this embodiment, the shoulder portion is arranged to allow the first elongated portion to be offset in a horizontal direction from second elongated portion. In accordance with another aspect of this embodiment, the part of the first elongated portion that extends into the housing interior is overmolded by the housing. In accordance with another aspect of this embodiment, the shoulder portion is overmolded by the housing. In accordance with another aspect of this embodiment, a part of the second elongated portion is overmolded by the housing. In accordance with another aspect of this embodiment, the overmolding of one or more of the first elongated portion, the second elongated portion and the shoulder portion environmentally isolates the housing exterior and the housing interior. In accordance with another aspect of this embodiment, the housing and the connector shell are nylon or glass-filled nylon.

In another embodiment, a battery has a battery management system (BMS) and a battery management system structure. The BMS structure has a housing having a housing interior and a housing exterior, a connector shell forming an interior and at least one electrically conductive signal pin. The BMS is positioned within the housing interior. The connector shell is integrally formed with the housing and is positioned on the housing exterior. Each of the at least one electrically conductive signal pins has a first elongated portion positioned partially within the connector shell interior and extending into the housing interior, a second elongated portion positioned within the housing interior and a shoulder portion coupling the first elongated portion to the second elongated portion. The shoulder portion is arranged with a bend so that the first elongated portion is substantially orthogonal to the second elongated portion.

In accordance with one aspect of this embodiment, the first elongated portion, the second elongated portion and the shoulder portion are formed as a unitary structure. In accordance with another aspect of this embodiment, the shoulder portion is arranged to allow the first elongated portion to be offset in a horizontal direction from second elongated portion. In accordance with another aspect of this embodiment, the part of the first elongated portion that extends into the housing interior is overmolded by the housing. In accordance with another aspect of this embodiment, the shoulder portion is overmolded by the housing. In accordance with another aspect of this embodiment, a part of the second elongated portion is overmolded by the housing. In accordance with another aspect of this embodiment, the overmolding of one or more of the first elongated portion, the second elongated portion and the shoulder portion environmentally isolates the housing exterior and the housing interior. In accordance with another aspect of this embodiment, the housing and the connector shell arc nylon or glass-filled nylon. In accordance with another aspect of this embodiment, the battery management system comprises at least one BMS electrical connector, each of the at least one BMS electrical connectors is arranged to physically and electrically couple to the second elongated portion of a corresponding electrically conductive signal pin. In accordance with another aspect of this embodiment, the at least one BMS electrical connector is biased to squeeze against the second elongated portion to make the physical and electrical coupling. In accordance with another aspect of this embodiment, the BMS includes at least one opening, each of the at least one opening being arranged to receive therethrough the second elongated portion of a corresponding electrically conductive signal pin. In accordance with another aspect of this embodiment, the battery further has at least one battery cell, the BMS being arranged to monitor at least one parameter of the at least one battery cell and to provide data corresponding to the parameter to an external system via the at least one electrically conductive signal pin.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a block diagram of an example battery constructed in accordance with the principles of present disclosure;

FIG. 2 is another diagram of an example battery constructed in accordance with the principles of present disclosure;

FIG. 3 is a top perspective view of an example battery management system and BMS housing with the top of the BMS housing removed and constructed in accordance with the principles of present disclosure;

FIG. 4 is another top perspective view of an example battery management system and BMS housing with the top of the BMS housing removed and constructed in accordance with the principles of present disclosure;

FIG. 5 is a side view of the example battery management system and BMS housing showing the connector and constructed in accordance with the principles of present disclosure;

FIG. 6 is another side view of the example battery management system and BMS housing showing the connector and constructed in accordance with the principles of present disclosure;

FIG. 7 is a top view of the example battery management system and BMS housing with the top of housing removed and constructed in accordance with the principles of present disclosure;

FIG. 8 is another top view of the example battery management system and BMS housing with the top of housing removed and constructed in accordance with the principles of present disclosure;

FIG. 9 is a top perspective view of an example connector signal pin constructed in accordance with the principles of present disclosure;

FIG. 10 is a side section view of a portion of the example battery management system housing and connector constructed in accordance with the principles of present disclosure;

FIG. 11 is a top perspective section view of a portion of the example battery management system housing and connector showing the interior electrical connection points of the connector signal pins constructed in accordance with the principles of present disclosure;

FIG. 12 is a front section view of a portion of the example battery management system housing and connector showing the electrical connections between the connector and the BMS circuit board constructed in accordance with the principles of present disclosure; and

FIG. 13 is another top perspective section view of a portion of the example battery management system housing and connector showing the interior electrical connection points of the connector signal pins constructed in accordance with the principles of present disclosure.

### DETAILED DESCRIPTION

Before describing in detail exemplary embodiments, it is noted that the embodiments reside primarily in combinations of apparatus components and processing steps related to an electrical connector for monitoring a vehicle battery, e.g., a non-cranking Li-Ion battery. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

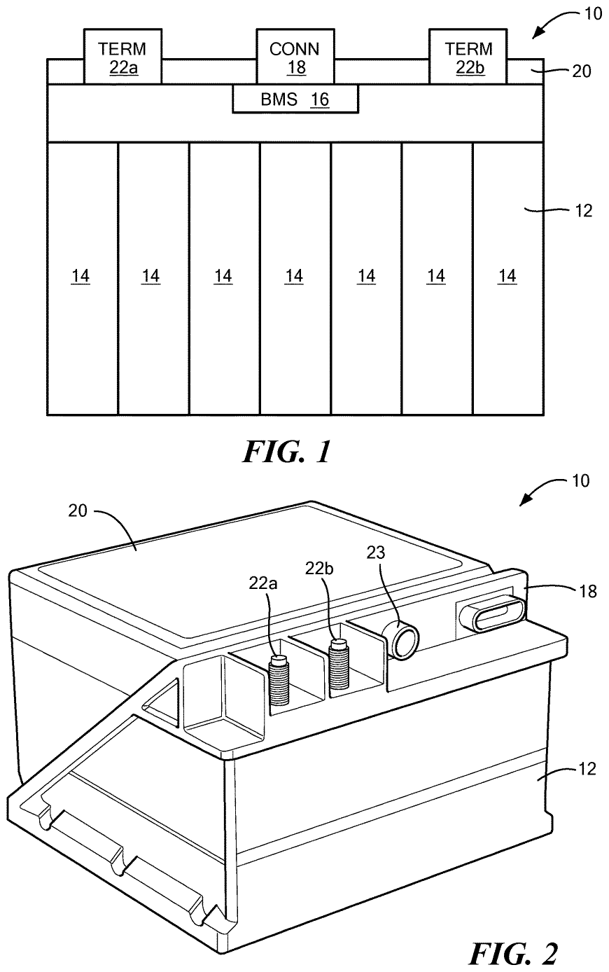

Referring now to the drawing figures in which like reference numbers refer to like elements, there is shown in FIGS. 1 and 2, a battery 10 constructed in accordance with the principles of the present disclosure. In some embodiments, battery 10 may be a Li-Ion battery. In other embodiments, battery 10 may be a lead acid battery. Battery 10 includes a housing 12 into which one or more cells 14, such as Li-Ion cells, are positioned. The cells 14 may be electrically interconnected (not shown in FIGS. 1 and 2), such as via an electrically conductive bus bar system which electrically interconnects the cells 14 in an electrically serial, electrically parallel or combination of electrically serial and parallel manner, depending on the intended voltage and current requirements.

A battery management system (BMS) 16 may be included. In some embodiments, the BMS may control certain aspects of battery 10 operation where the control signals are transmitted to and from external system components via a monitoring connector 18 and/or BMS 16 measure certain battery parameters, e.g., voltage, and provide the data to an external system via the monitoring connector 18. Thus, BMS 16 may make use of the monitoring connector 18 that allows for an external electrical connection to the vehicle's data bus, or to some other communication device. The monitoring connector 18 can, in some embodiments, be integrated with the housing 12, such as in a cover 20 of the housing 12 and/or as part of a BMS housing (discussed below). Battery 10 also includes terminals, such as a negative terminal 22a and a positive terminal 22b (collectively referred to as terminals 22) to provide the contact points for electrical connection of the battery 10 to the vehicle to provide the power, e.g., auxiliary, starting, locomotive, etc., to the vehicle. Terminals 22 are arranged to protrude through housing 12, such as protruding through cover 20. Terminals 22 may be electrically connected to the bus bars inside housing 12 and/or directly connected to the cells 14 (not shown in the FIGS). In some embodiments, housing 12 includes one or more vent holes 23 to allow venting from one or more of the cells 14, e.g., Li-Ion cells. Battery 10 can be arranged to provide many power capacities and physical sizes, and to operate under various parameters and parameter ranges.

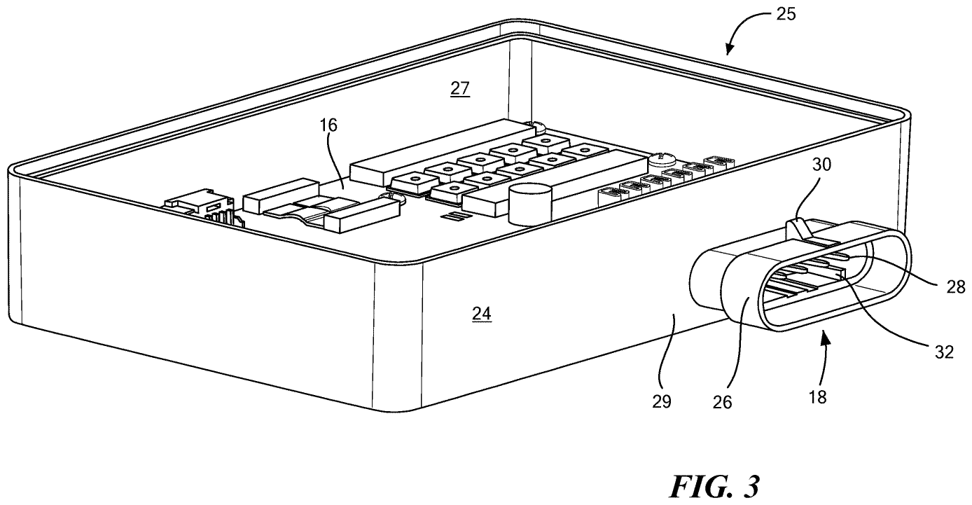

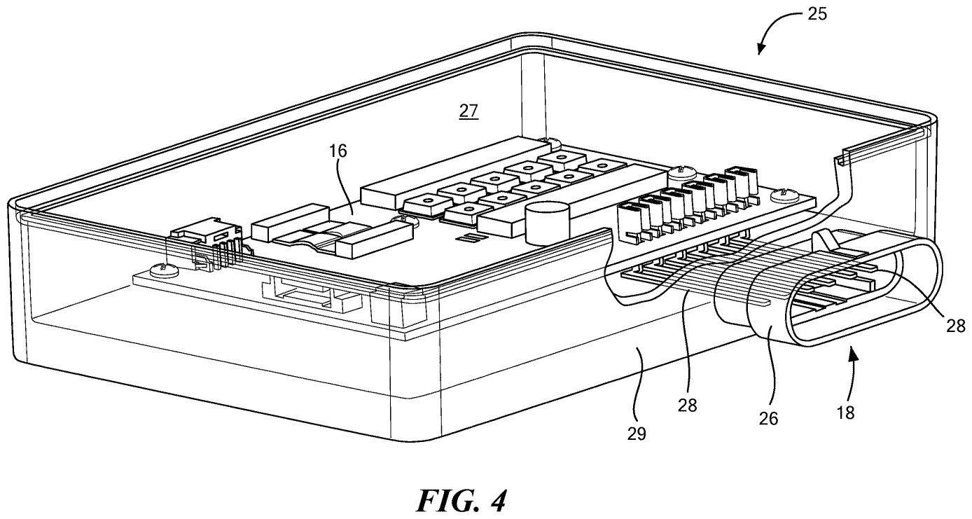

FIGS. 3 and 4 are top perspective views of an example BMS and BMS housing with the top of BMS housing removed and constructed in accordance with the principles of present disclosure. As is shown in FIGS. 3 and 4, BMS 16 is positioned inside the inner volume formed by BMS housing 24. BMS structure 25 is formed by BMS housing 24 and connector 18. BMS housing 24 includes a housing interior 27 and a housing exterior 29. BMS 16 is positioned within the housing interior 27. Connector 18 includes connector shell 26 and one or more electrically conductive connector signal pins 28 positioned in the inner volume of connector shell 26. Connector shell 26 may be formed, e.g., molded, as an integral unit, but exterior to BMS housing 24 such that there is no opening or gap between the exterior of connector shell 26 and BMS housing 24. In other words, by forming connector shell 26 as part of BMS housing 24, an environmental barrier is formed between exterior of connector shell 26 and BMS housing 24. Although FIGS. 3 and 4 refer to BMS housing 24 separate from discussion above regarding battery housing 12, it is understood that BMS housing 24 can be formed along with or as a part of the overall housing 12. BMS housing 24 is shown and described separately from housing 12 solely to aid understanding of the concepts disclosed herein and is not intended to be limiting or to imply that housing 12 is physically separate from BMS housing 24. Connector 18 may also include one or more alignment tabs 32 (discussed below). In some embodiments, BMS housing 24 (and/or housing 12) can be made of nylon or other suitable thermoplastic polymer. In some embodiments, a glass filler can be used with the nylon. In some embodiments, the thermoplastic polymer can be all or part recycled post-consumer waste.

It is noted that embodiments herein are described with respect to a BMS, BMS housing and BMS structure, but it should be understood that the description made with reference to BMS 16, BMS housing 24 and BMS structure 25, and a BMS in general, are provided for ease of understanding. Implementations are not limited to battery management system hardware, e.g., circuit boards, and that circuit boards arrangement to perform other battery-related functions can be used instead of a circuit board and hardware/software/firmware that specifically provides BMS functionality. Thus, as used herein, the term BMS 16 is intended to refer to a circuit board and hardware/software/firmware that relates to a device that performs some battery-related function.

Electrically conductive signal pins 28 provide electrical signal paths from the exterior of BMS housing 24 to BMS 16 positioned within BMS housing 24. In operation, a complementary, e.g., female connector is inserted into and mates with connector shell 26, being retained by connector shell 26 for example by retaining tab 30. Although not shown, the female connector may contain one or more gaskets surrounding the connector shell such that, when coupled with connector shell 26, provides a hermetic seal between the interior 27 of BMS housing 24 and the exterior 29 of BMS housing 24 (when a lid is sealed to BMS housing 24 to form a confined volume). The female connector has complimentary electrical connection receptacles to receive corresponding electrically conductive connector signal pins 28, to thereby allow signals to/from BMS 16 to external sources/users of the signal information. FIG. 4 shows a view similar to the view of FIG. 3, but with BMS housing 24 and connector shell 26 shown transparently to aid understanding of the relationship between the electrically conductive connector signal pins 28 and BMS 16 as the electrically conductive connector signal pins 28 pass from the exterior 29 of BMS housing 24 to the interior 27 of BMS housing 24. In some embodiments, connector signal pins are made of a brass alloy. Of course, other suitable metals can be used based on design need provided that the metal is capable of carrying a signal at the intended frequency, amplitude, DC voltage, etc. BMS 16 is arranged to monitor at least one parameter of at least one battery cell 14 and to provide data corresponding to the parameter to an external system via at least one electrically conductive signal pin 28.

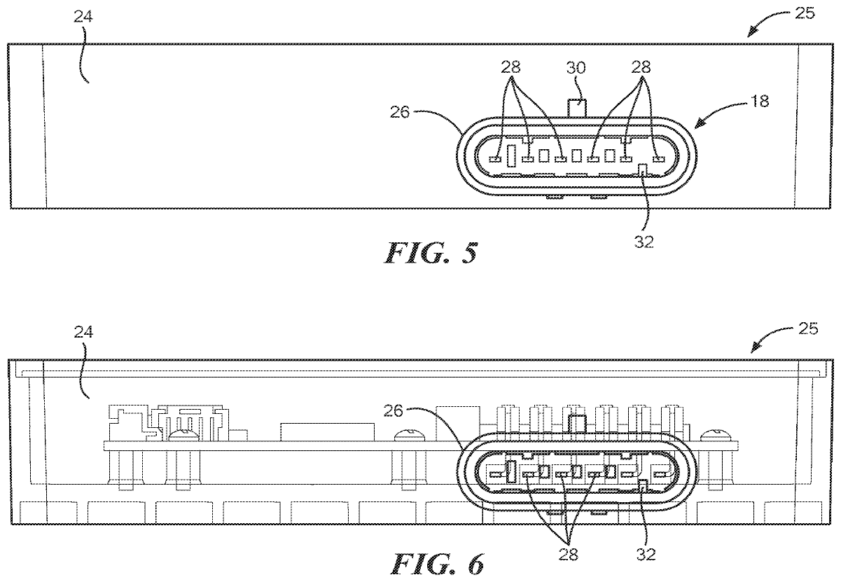

FIGS. 5 and 6 are side views of the example battery management system and BMS housing 24 showing the connector 18. FIG. 6 shows a view similar to the view of FIG. 5, but with BMS housing 24 and connector shell 26 shown transparently to aid understanding of the relationship between the electrically conductive connector signal pins 28 and BMS 16 as the electrically conductive connector signal pins 28 pass from the exterior 29 of BMS housing 24 to the interior 27 of BMS housing 24. Referring to FIGS. 5 and 6, it can been seen that, in some embodiments, connector 18 also includes alignment tabs 32 to facilitate alignment of the female connector (not shown) and connector 18, and to ensure proper orientation of the female connector (not shown) and connector 18 when the female connector is inserted into connector 18.

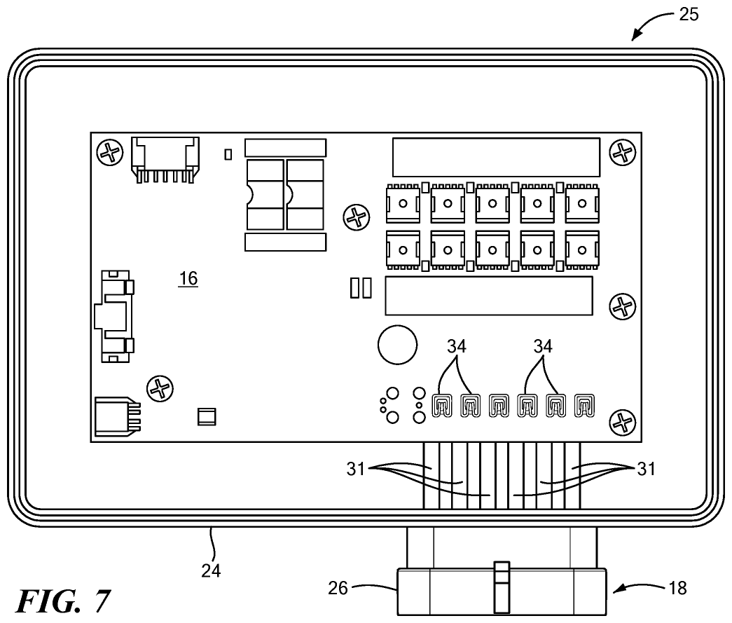

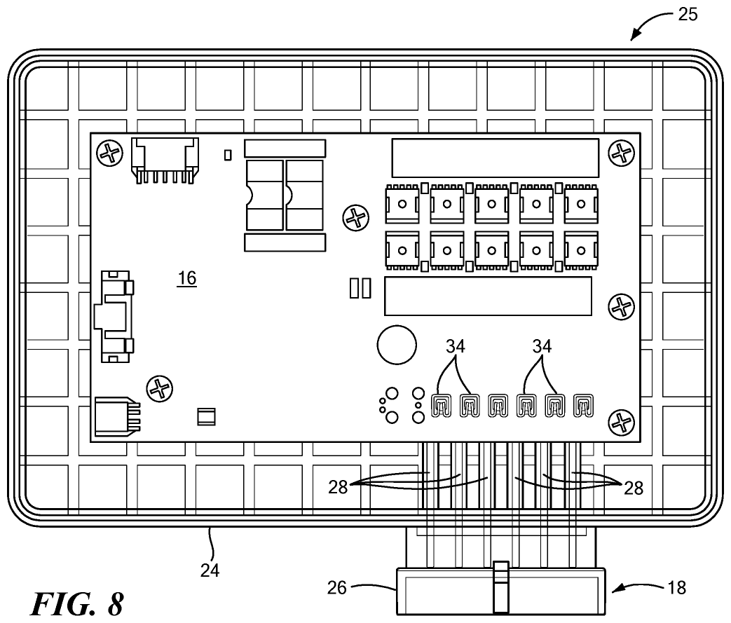

FIGS. 7 and 8 are top views of the example battery management system and BMS housing 24 with the top of BMS housing 24 removed and constructed in accordance with the principles of present disclosure. FIG. 7 shows overmolding 31 inside of which is a corresponding portion of fist elongated portion 36. FIG. 8 shows a view similar to the view of FIG. 7, but with connector shell 26 shown transparently to aid understanding of the relationship between the electrically conductive connector signal pins 28 and BMS 16 as the electrically conductive connector signal pins 28 pass from the exterior 29 of BMS housing 24 to the interior 27 of BMS housing 24. As shown in FIGS. 7 and 8, BMS 16 includes one or more BMS electrical connectors 34. BMS electrical connectors 34 are arranged to mate with a corresponding one of electrically conductive connector signal pins 28 when BMS 16 is inserted into BMS housing 34 to thereby provide an electrical signal path from the exterior of BMS housing 24 to the componentry of BMS 16.

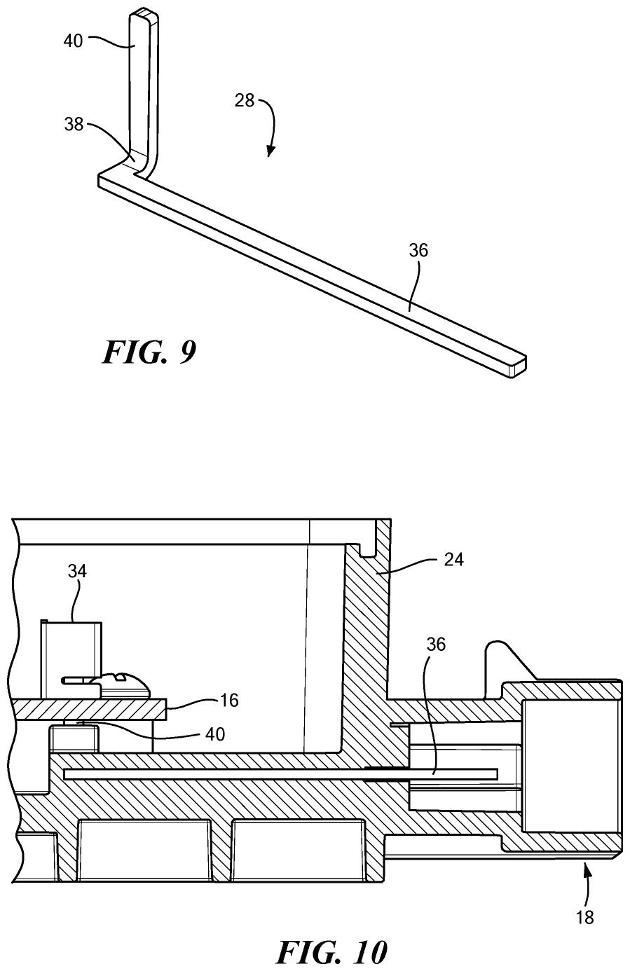

FIG. 9 is a top perspective view of an example electrically conductive signal pin 28. Electrically conductive signal pin 28 includes first elongated portion 36 contiguous with shoulder portion 38 which is contiguous with second elongated portion 40. Shoulder portion 38 includes an approximately 90 degree bend so that first elongated portion 36 and second elongated portion 40 are orthogonal with respect to one another. Put another way, in one orientation, first elongated portion 36 may be horizontal and parallel to BMS 16 when installed, while second elongated portion 40 is vertical and perpendicular to the longitudinal plane of BMS 16 when installed. In some embodiments, shoulder portion 38 is arranged to allow first elongated portion 36 to be offset in the horizontal direction, i.e., coplanar with first elongated portion 36, from second elongated portion 40. In some embodiments, portions 36, 38 and 40 can be formed as a single metallic piece, i.e., as a unitary structure, e.g., by stamping or molding.

FIG. 10 is a side section view of a portion of the example battery management system housing 24 and connector 18 constructed in accordance with the principles of present disclosure. In particular, FIG. 10 shows first elongated portion 36 protruding into the inner part of BMS housing 24, and second elongated portion 40 coupled with a BMS electrical connector 34. In one embodiment, the part of first elongated portion 36 that is inside the outer wall of BMS housing 24 and part of second elongated portion 40 (as well as shoulder portion 38) can be overmolded with BMS housing 24 to thereby retain electrically conductive signal pin 28 in place to facilitate assembly of BMS 16.

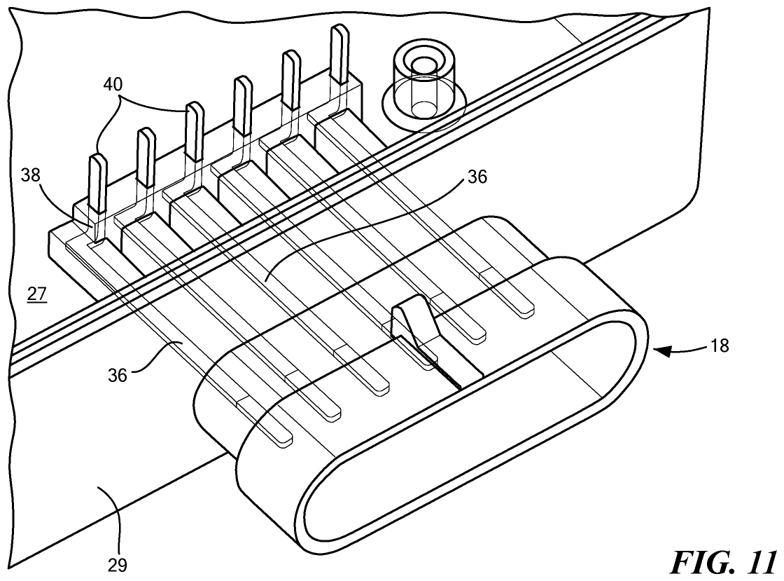

FIG. 11 is a top perspective section view of a portion of the example battery management system housing 24 and connector 18 showing the interior electrical connection points of the connector signal pins constructed in accordance with the principles of present disclosure. Shown as a partially transparent view, the arrangement and orientation of the parts of electrically conductive connector signal pins 28 can be seen, including the part of first elongated portion 36 and second elongated portion 40 that is overmolded with BMS housing 24. The overmolding also serves to facilitate environmental isolation of connector 18 between the outside of BMS housing 24 and the inside of BMS housing 24. For example, the part of first elongate portion 36 that is exterior to battery management system housing 24, i.e., positioned within connector shell 26, can be sealed within the overmolded portion of BMS housing 24 so that the interior 27 of BMS housing 24 remains environmentally separated from the exterior 29 of BMS 24 despite the protrusion of electrically conductive signal pin 28 through the wall forming BMS housing 24. In another embodiment, electrically conductive connector signal pins 28, e.g., at least a portion of one or more of the first elongated portion 36, the shoulder portion 38 and the second elongated portion 40, can be affixed to BMS housing 24 and not integrated with BMS housing 24 via overmolding. In such cases, affixation can be obtained by glue or by using a non-conductive, e.g., thermoplastic polymer, cover/strap to retain electrically conductive connector signal pins 28 in place.

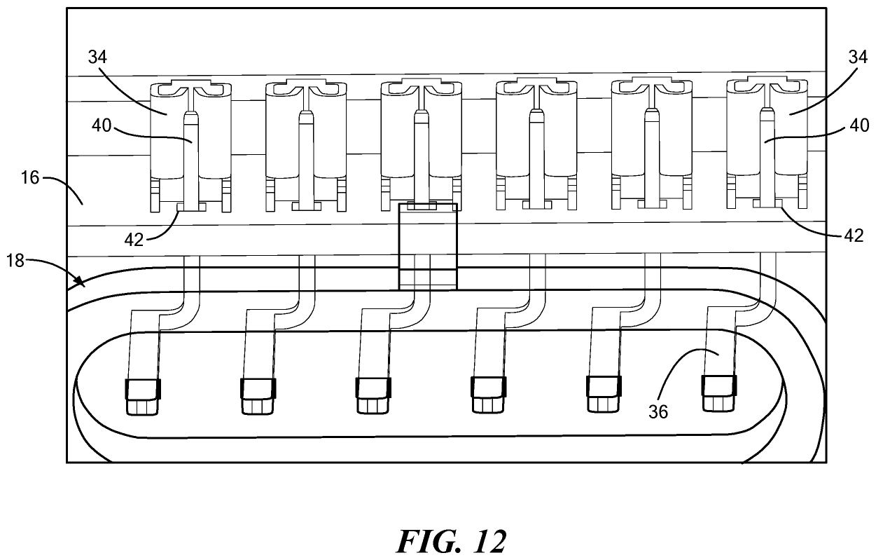

FIG. 12 is a front section view of a portion of the example battery management system housing 24 and connector 18 showing the electrical connections between the connector and the BMS circuit board constructed in accordance with the principles of present disclosure. FIG. 12 shows second elongated portion 40 protruding through opening 42 in BMS 16, specifically the circuit board portion of BMS 16. This arrangement allows second elongated portion 40 of electrically conductive signal pin 28 to physically and electrically couple with a corresponding BMS electrical connector 24 of BMS 16.

Such an arrangement also simplifies assembly as compared with traditional techniques of soldering or welding signal pins to corresponding connectors on a BMS circuit board. In accordance with the present disclosure and in one embodiment, installation of BMS 16 into BMS housing 24 is accomplished by aligning openings 42 with their corresponding second elongated portions 40 of electrically conductive connector signal pins 28, and inserting BMS 16 into BMS housing 24 so that second elongated portions 40 are received through corresponding openings 42. When fully inserted into BMS housing 24, second elongated portions 40 are caused to contact and physically and electrically couple with corresponding BMS electrical connectors 34. BMS electrical connectors 34 are arranged so that opposite sides of BMS electrical connectors are biased to squeeze against corresponding opposite sides of second elongated portions 40. This arrangement advantageously allows BMS electrical connectors 34 to electrically retainably couple with electrically conductive connector signal pins 28 without the need for welding, soldering, etc. Once installed, BMS 16 can be retained in BMS housing 24 using one or more fasteners, e.g., screws, rivets, adhesive, etc.

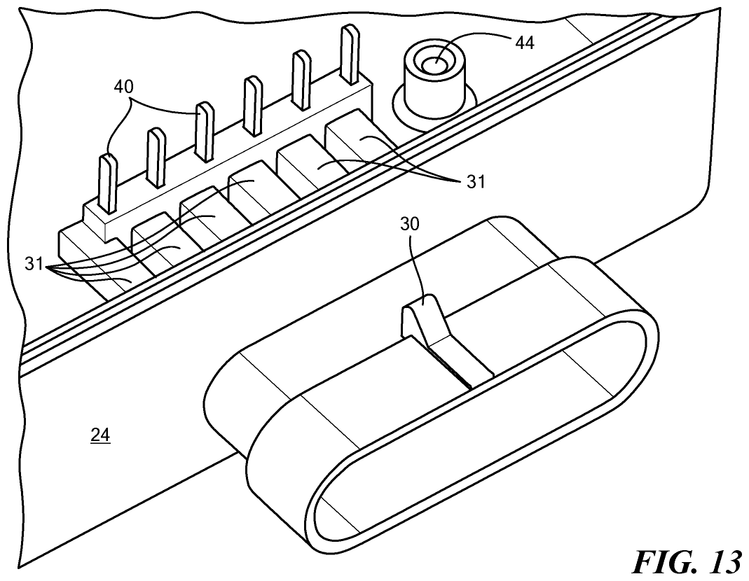

FIG. 13 is another top perspective section view of a portion of the example battery management system housing 24 and connector 18 showing the interior electrical connection points of electrically conductive connector signal pins 28, specifically the exposed parts of second elongated portions 40 available for coupling with BMS electrical connectors 34. FIG. 13 also shows an example affixation point 44 to which the circuit board of BMS 16 can be affixed such as by a screw protruding through a corresponding opening in the circuit board of BMS 16.

In one embodiment, a battery management system structure 25 has a housing 24 having a housing interior 27 and a housing exterior 29, a connector shell 26 forming an interior and at least one electrically conductive signal pin 28. The connector shell 26 is integrally formed with the housing 24 and is positioned on the housing exterior 29. Each of the at least one electrically conductive signal pins 28 has a first elongated portion 36 positioned partially within the connector shell 26 interior and extending into the housing interior 27, a second elongated portion 40 positioned within the housing interior 27 and a shoulder portion 38 coupling the first elongated portion 36 to the second elongated portion 40. The shoulder portion 38 is arranged with a bend so that the first elongated portion 36 is substantially orthogonal to the second elongated portion 40.

In accordance with an aspect, the first elongated portion 36, the second elongated portion 40 and the shoulder portion 38 are formed as a unitary structure. In accordance with another aspect of this embodiment, the shoulder portion 38 is arranged to allow the first elongated portion 36 to be offset in a horizontal direction from second elongated portion 40. In accordance with another aspect of this embodiment, the part of the first elongated portion 36 that extends into the housing interior 27 is overmolded by the housing 24. In accordance with another aspect of this embodiment, the shoulder portion 38 is overmolded by the housing 24. In accordance with another aspect of this embodiment, a part of the second elongated portion 40 is overmolded by the housing 24. In accordance with another aspect of this embodiment, the overmolding of one or more of the first elongated portion 36, the second elongated portion 40 and the shoulder portion 38 environmentally isolate the housing exterior 29 and the housing interior 27. In accordance with another aspect of this embodiment, the housing 24 and the connector shell 26 are nylon or glass-filled nylon.

In another embodiment, a battery 10 has a battery management system (BMS) 16 and a battery management system structure 25. The BMS structure 25 has a housing 24 having a housing interior 27 and a housing exterior 29, a connector shell 26 forming an interior and at least one electrically conductive signal pin 28. The BMS 16 is positioned within the housing interior 27. The connector shell 26 is integrally formed with the housing 24 and is positioned on the housing exterior 29. Each of the at least one electrically conductive signal pins 28 has a first elongated portion 36 positioned partially within the connector shell 26 interior and extending into the housing interior 27, a second elongated portion 40 positioned within the housing interior 27 and a shoulder portion 38 coupling the first elongated portion 36 to the second elongated portion 40. The shoulder portion 38 is arranged with a bend so that the first elongated portion 36 is substantially orthogonal to the second elongated portion 40.

In accordance with an aspect, the first elongated portion 36, the second elongated portion 40 and the shoulder portion 38 are formed as a unitary structure. In accordance with another aspect of this embodiment, the shoulder portion 38 is arranged to allow the first elongated portion 36 to be offset in a horizontal direction from second elongated portion 40. In accordance with another aspect of this embodiment, the part of the first elongated portion 36 that extends into the housing interior 27 is overmolded by the housing 24. In accordance with another aspect of this embodiment, the shoulder portion 38 is overmolded by the housing 24. In accordance with another aspect of this embodiment, a part of the second elongated portion 40 is overmolded by the housing 24. In accordance with another aspect of this embodiment, the overmolding of one or more of the first elongated portion 36, the second elongated portion 40 and the shoulder portion 38 environmentally isolate the housing exterior 29 and the housing interior 27. In accordance with another aspect of this embodiment, the housing 24 and the connector shell 26 are nylon or glass-filled nylon.

In accordance with another aspect of this embodiment, the battery management system 16 comprises at least one BMS electrical connector 34, each of the at least one BMS electrical connectors 34 is arranged to physically and electrically couple to the second elongated portion 40 of a corresponding electrically conductive signal pin 28. In accordance with another aspect of this embodiment, the at least one BMS electrical connector 34 is biased to squeeze against the second elongated portion 40 to make the physical and electrical coupling. In accordance with another aspect of this embodiment, the BMS 16 includes at least one opening 42, each of the at least one opening 42 being arranged to receive therethrough the second elongated portion 40 of a corresponding electrically conductive signal pin 28. In accordance with another aspect of this embodiment, the battery 10 further has at least one battery cell 14, the BMS 16 being arranged to monitor at least one parameter of the at least one battery cell 14 and to provide data corresponding to the parameter to an external system via the at least one electrically conductive signal pin 28.

As noted above, implementations are not limited to battery management system hardware, e.g., circuit boards, and that circuit boards arranged to perform other battery-related functions can be used instead of a circuit board and hardware/software/firmware that specifically provides BMS functionality. In other words, electrical connectors 34 can be provided on a circuit board that provides functions different from BMS functions such that this circuit board can be connected to electrically conductive signal pins 28 using the techniques and arrangements as described herein.

It is understood that all specification values shown and described herein are non-limiting examples for implementations of batteries 10 and connectors 18 constructed in accordance with the principles of the disclosure provided herein. It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A battery management system structure the battery management system structure comprising:
a housing having a housing interior and a housing exterior;
a connector shell forming an interior, the connector shell being integrally formed with the housing and being positioned on the housing exterior; and
at least one electrically conductive signal pin each of the at least one electrically conductive signal pins having:
a first elongated portion being positioned partially within the connector shell interior and extending into the housing interior;
a second elongated portion positioned within the housing interior; and
a shoulder portion coupling the first elongated portion to the second elongated portion, the shoulder portion arranged with a bend so that the first elongated portion is substantially orthogonal to the second elongated portion.

2. The battery management system structure of claim 1, wherein the first elongated portion, the second elongated portion and the shoulder portion are formed as a unitary structure.

3. The battery management system structure of claim 1, wherein the shoulder portion is arranged to allow the first elongated portion to be offset in a horizontal direction from second elongated portion.

4. The battery management system structure of claim 1, wherein the part of the first elongated portion that extends into the housing interior is overmolded by the housing.

5. The battery management system structure of claim 1, wherein the shoulder portion is overmolded by the housing.

6. The battery management system structure of claim 1, wherein a part of the second elongated portion is overmolded by the housing.

7. The battery management system structure of claim 1, wherein the overmolding of one or more of the first elongated portion, the second elongated portion and the shoulder portion environmentally isolates the housing exterior and the housing interior.

8. The battery management system structure of claim 1, wherein the housing and the connector shell are nylon or glass-filled nylon.

9. A battery, the battery comprising:
a battery management system, BMS; and
a battery management system structure, the battery management system structure comprising:
a housing having a housing interior and a housing exterior, the BMS being positioned within the housing interior;
a connector shell forming an interior, the connector shell being integrally formed with the housing and being positioned on the housing exterior; and
at least one electrically conductive signal pin each of the at least one electrically conductive signal pins having:
a first elongated portion being positioned partially within the connector shell interior and extending into the housing interior;
a second elongated portion positioned within the housing interior; and
a shoulder portion coupling the first elongated portion to the second elongated portion, the shoulder portion arranged with a bend so that the first elongated portion is substantially orthogonal to the second elongated portion.

10. The battery of claim 9, wherein the first elongated portion, the second elongated portion and the shoulder portion are formed as a unitary structure.

11. The battery of claim 9, wherein the shoulder portion is arranged to allow the first elongated portion to be offset in a horizontal direction from second elongated portion.

12. The battery of claim 9, wherein the part of the first elongated portion that extends into the housing interior is overmolded by the housing.

13. The battery of claim 9, wherein the shoulder portion is overmolded by the housing.

14. The battery of claim 9, wherein a part of the second elongated portion is overmolded by the housing.

15. The battery of claim 12, wherein the overmolding of one or more of the first elongated portion, the second elongated portion and the shoulder portion environmentally isolates the housing exterior and the housing interior.

16. The battery of claim 9, wherein the housing and the connector shell are nylon or glass-filled nylon.

17. The battery of claim 9, wherein the battery management system comprises at least one BMS electrical connector, each of the at least one BMS electrical connectors arranged to physically and electrically couple to the second elongated portion of a corresponding electrically conductive signal pin.

18. The battery of claim 17, wherein the at least one BMS electrical connector is biased to squeeze against the second elongated portion to make the physical and electrical coupling.

19. The battery of claim 12, wherein the BMS comprises at least one opening, each of the at least one opening being arranged to receive therethrough the second elongated portion of a corresponding electrically conductive signal pin.

20. The battery of claim 12, further comprising at least one battery cell, the BMS being arranged to monitor at least one parameter of the at least one battery cell and to provide data corresponding to the parameter to an external system via the at least one electrically conductive signal pin.
